(19) United States
(12) Patent Application Publication
(10) Pub. No.: US 2018/0084800 A1
(43) Pub. Date: Mar. 29, 2018

(54) MACHINE FOR PREPARING A COOLED OR HEATED PRODUCT WITH ACCURATE TEMPERATURE CONTROL

(71) Applicant: NESTEC S.A., Vevey (CH)

(72) Inventor: Andre Noth, Pully (CH)

(21) Appl. No.: 15/568,712

(22) PCT Filed: Apr. 21, 2016
(86) PCT No.: PCT/EP2016/058849

§ 371 Date: Oct. 23, 2017

(30) Foreign Application Priority Data
Apr. 27, 2015 (EP) 15165183.3

(51) Int. Cl. A23G 9/22; A23G 9/08; A23G 9/16

(52) U.S. Cl. CPC A23G 9/228; A23G 9/16; A23G 9/08

(57) ABSTRACT

A machine (20) for the preparation of a cooled or heated product comprising: —a receiving seat (1) for accommodating a container (8) comprising at least part of the ingredients for the preparation of a product; —a heat exchange element (1a) arranged to be in contact with an outer wall of the container (8), when the container (8) is placed in the receiving seat (1), and —temperature sensing means (100) arranged to measure the temperature at an outer wall of the container (8) when the container (8) is placed in the receiving seat (1), the temperature sensing means (100) comprising at least two temperature sensors, a primary temperature sensor (101) arranged to measure the temperature (T_{S1}) in proximity to an outer wall of the container (8) and a secondary primary sensor (102) arranged to measure the temperature (T_{S2}) in a position located in the heat path through which heat travels between the inside the container (8) and the external environment.

### FIELD OF THE INVENTION

The present invention is directed to a system for preparing a cooled or heated product, preferably an aerated and cooled confectionary such as ice cream or whipped yogurt, the system comprising a preparation machine and a dedicated container. In particular, the invention relates to a preparation machine providing an accurate temperature control of the product during the preparation process of the cooled or heated product.

### BACKGROUND OF THE INVENTION

Currently, the majority of ice cream consumption at home concerns products bought frozen at the point of sales. As for dairy products, there are several drawbacks such as the need to transport the products at home rapidly in order to keep them at the cold (frozen) state, the need to store them in a freezer and the limited number of flavors available considering standard freezer volume. Additionally, the texture of such products is rather hard and far from the freshly made ice cream.

An alternative solution available today is the use of an ice cream machine to produce fresh ice cream. Thereby, although the obtained texture of the resulting product is more satisfactory, the preparation procedure by means of the known ice-cream machines has several drawbacks.

In particular, all the ingredients must be mixed previously, the volume of such machines corresponds usually to five or more serving portions of the same flavor and the time necessary is about half of an hour. Moreover, the ingredients necessary for the preparation come in contact with a large number of parts of the preparation machine (e.g. a stirrer, tanks, or a dispenser), which all have to be cleaned. Other alternatives imply a preparation at ambient temperature before the freezing phase in a standard freezer. Hence, they are also time consuming and require cleaning tasks.

Therefore, there is a demand for increasing the convenience of the preparation of cool confectionery or desserts, in particular, reducing the preparation time, avoiding the hassle of cleaning the surfaces in contact with food and delivering on demand an appealing texture and diversity of products.

US 2006/0263490 for example relates to a frozen confectionary maker comprising a cup holder for removably receiving a cup with a cavity in its wall and base for receiving freezable solution. The cup of the confectionary maker is designed to serve for the preparation and serving of the cup. WO 2010/149509 for example relates to a system for preparing a frozen confectionary, the system comprising a cylindrical container for being inserted into a dedicated preparation device, said container comprising a predefined amount of ingredients. The device of the system comprises a container holder having an inner heat exchange surface designed for being in tight contact with the container when being placed in the container holder and a delivery outlet for serving the single portion prepared within the container to a dedicated receiving receptacle.

Moreover, it is to be taken into consideration that, in the domain of food and drink dispensing machines, one demand that is becoming a standard is the absence of cleaning after the preparation: one way to ensure a fully clean preparation of the product delivered consists in avoiding any product transfer by both processing and delivering the product in its initial container. In this regard, one of the processes that can be applied to the initial ingredients to obtain the final product is heat transfer (heating and/or cooling). In the present case where no product transfer is allowed, the most obvious way to achieve this heat transfer is by using conduction through the packaging. This is for example done through the evaporator of a vapor compression refrigeration circuit for cooling. Therefore, it is common that during the preparation process in the known devices, a heat transfer is generally obtained between the container body holding the ingredients and the inner heat exchange surface of the device by means of conduction through the outer body of the container.

A problem is to obtain an accurate information of the product temperature during the preparation, in particular, during stirring so that it is made possible to adjust the preparation parameters (cooling power, rotation velocity, rotation direction, timing, etc.) accordingly to obtain the optimal final texture of the cooled product.

However, accurate temperature information would require placing a temperature probe into the container during the preparation process, which in turn would lead to a complex construction of machine and the hassle of cleaning the temperature probe.

As a consequence, in a more detailed analysis, the information of the product temperature is impossible or difficult to obtain, as it is further explained in what follows:
using direct measurement in the case of a close product container is impossible, as there is no access to the product (see reference letter A in FIG. 3);
direct measurement in the case of an open product container would require a cleaning of the sensor probe (see reference letter B in FIG. 3);
measurement of temperature on the heating/cooling surface of the machine, for example the evaporator, is possible (see reference letter C in FIG. 3) but doesn't reflect the product's temperature;
contactless sensors are costly and sensitive to splashes that can lead to obstruction (see reference letter D in FIG. 3).

In document EP 13190810.5 belonging to the same applicant, a system is presented where the temperature sensor is placed in contact with the container at a location such that it reflects with high confidence the product temperature, without the temperature sensor entering in direct contact with the product and thus avoiding any cleaning needs (see reference letter E in FIG. 4). However, in such a system as the one presented, there is an offset between the temperature sensed and the real product temperature, due to the fact that it is impossible to ensure:
perfect conduction between the sensor and the product in the cup or container;
perfect insulation between the sensor and the environment.

Hence, in a system as the one presented in EP 13190810.5, the sensed temperature is an intermediate value between the product temperature and the environment temperature, two values that cannot be estimated based on only one sensed value.

The present invention thus aims at providing dedicated means for obtaining reliable information regarding the temperature of a product held within such container when being accommodated in a machine preferably for preparation of an aerated and cooled confectionary product, such that the product temperature is estimated reliably and accurately and even in cases where the environment temperature changes. Moreover, the system of the invention requires no cleaning, is simple and not costly.

### OBJECT AND SUMMARY OF THE INVENTION

The present invention seeks to address the above-described problems. The invention also aims at other objects and particularly the solution of other problems as will appear in the rest of the present description.

According to a first aspect, the invention refers to a machine for the preparation of a cooled or heated product comprising:
a receiving seat for accommodating a container comprising at least part of the ingredients for the preparation of a product;
a heat exchange element arranged to be in contact with an outer wall of the container, when the container is placed in the receiving seat, and
temperature sensing means arranged to measure the temperature at an outer wall of the container when the container is placed in the receiving seat.

The temperature sensing means comprise at least two temperature sensors, a primary temperature sensor arranged to measure the temperature T_{S1} in proximity to an outer wall of the container and a secondary primary sensor arranged to measure the temperature T_{S2} in a position located in the heat path through which heat travels between the inside of the container and the external environment.

According to the invention, the temperature in the product Tₚ is extrapolated from the temperature T_{S1} measured by the primary temperature sensor and the temperature T_{S2} measured by the secondary temperature sensor.

Typically, the machine further comprises a control unit arranged to make an extrapolation between the two sensed temperatures T_{S1}, T_{S2} and calculate the product temperature Tₚ.

The extrapolation is made using pre-identified values that represent the conductivity, the surface dimension and the thickness of the material layers between the product in the container and the primary temperature sensor, and between the primary temperature sensor and the secondary temperature sensor.

Typically, the machine further comprises pushing means configured to cooperate with the temperature sensing means in order to ensure contact of the sensing means with an outer wall of the container.

The machine preferably further comprises a flexible membrane configured to cooperate with the pushing means adapting to containers having different sizes.

According to the present invention, the machine preferably further comprises mechanical stops arranged to cooperate with the flexible membrane and limit its deformation at least in one of its directions of deformation.

Preferably, at least one of the two sensors is arranged in an insulating movable support being movable to assure contact of the sensing means with an outer wall of the container.

Typically, at least one of the two sensors is arranged in a highly conductive support (ensuring a high conductivity path between the at least one sensor and an outer wall of the container.

Preferably, the temperature sensing means are arranged within an insulating support isolating them from the external environment. The insulating support is typically made of rubber, silicon, foam or a similar material.

According to a second aspect, the invention refers to a system comprising a machine as the one described and a container cooperating with such machine to prepare a cooled or heated product within said container.

Typically, the container comprises an additional heat conducting portion arranged where the temperature sensing means contact an outer wall of the container when the container is placed in the receiving seat of the machine.

Preferably, the container is configured rigid, preferably configured as a capsule, or flexible, preferably configured as a pouch or sachet.

According to the invention, the product in the container is prepared adapted to the type of container, its size and/or its type of material.

### BRIEF DESCRIPTION OF THE DRAWINGS

Further features, advantages and objects of the present invention will become apparent for a skilled person when reading the following detailed description of embodiments of the present invention, when taken in conjunction with the figures of the enclosed drawings.

FIG. 1 shows a schematic view of the system and the machine for preparing a cooled or heated product according to the invention.

FIGS. 2a and 2b show different possible shapes of a container body according to the present invention.

FIG. 3 shows a potential solution for product temperature measurement and associated sensor location, in a machine for preparing cooled confectionary according to known prior art.

FIG. 4 shows a possible proposed location of the temperature sensor in direct contact in a machine for preparing cooled confectionary according to the known prior art.

FIG. 5 shows a spring system ensuring constant contact pressure of the temperature sensor on the cup or container in a machine for preparing cooled confectionary according to the known prior art.

FIGS. 6a-b-c show different views of the two sensors system for measuring temperature in a machine for preparing a cooled or heated product according to the present invention.

FIG. 7 shows a detailed sectional view of the two sensors system for measuring temperature in a machine for preparing a cooled or heated product according to the present invention, when pushed towards the cup or container.

FIG. 8 shows a schematic view of the heat path between the environment and the product in a machine for preparing a cooled or heated product according to the present invention.

FIGS. 9a-b show detailed sectional views of the two sensors system for measuring temperature in a machine for preparing a cooled or heated product according to the present invention, when a flexible lever is used.

FIG. 10 shows a detailed view of mechanical stops arranged in the two sensors system for measuring temperature in a machine for preparing a cooled or heated product according to the present invention.

### DETAILED DESCRIPTION OF THE FIGURES

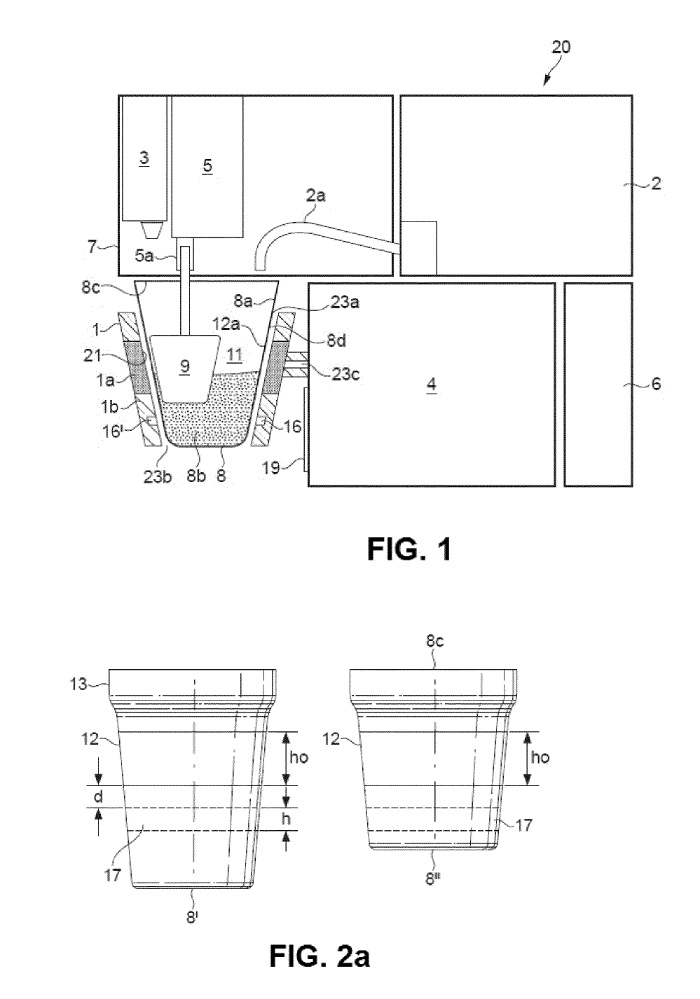

FIG. 1 relates to a preferred embodiment of a system according to the present invention comprising a container 8 and a food preparation machine 20 designed for preparing a frozen confectionary in the container 8. According to the invention, not only cooled but also heated products can be prepared in the container 8, though the preferred case will be that of preparing a cooled product. However, the invention is not limited to cooled products only, and shall be extended to the preparation of heated products too.

Preferably, the container 8 will be configured as a single-use container and will typically comprise inside at least part of the ingredients for the preparation of the final product; according to a different embodiment, and also comprised within the scope of the present invention, the ingredients can be dispensed into the container 8 coming from a dispensing container. In one way or the other, the ingredients will be finally processed in the container 8.

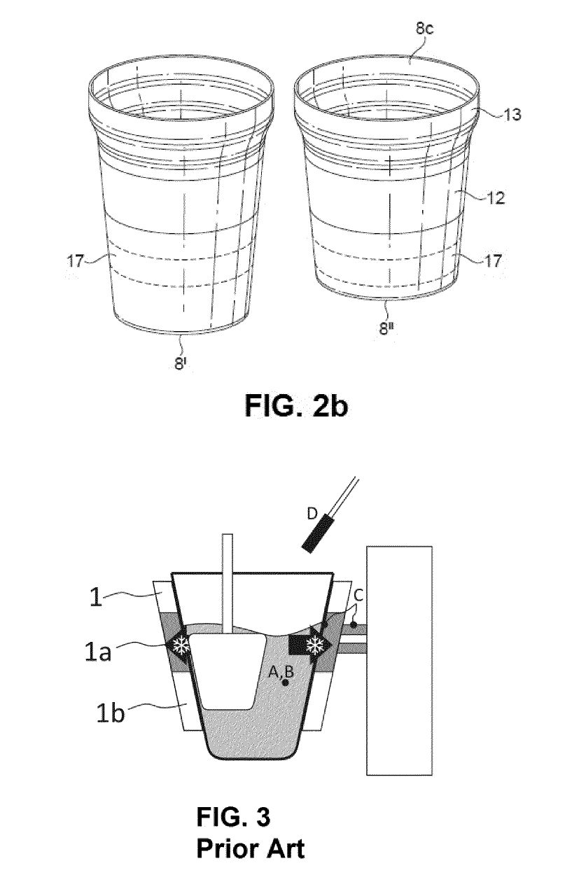

The machine 20 preferably comprises a receiving seat 1 for receiving the container 8 therein. The receiving seat 1 is preferably shaped in V-form or truncated conical form when seen in sectional side view as indicated in FIG. 1. Thereby, the receiving seat 1 preferably comprises an insertion opening 23a in which the container 8 may be placed, as well as a lower opening 23b enabling the accommodation of containers of various sizes. Further, the receiving seat 1 is preferably formed as an annular ring portion. The receiving seat 1 is preferably connected to a housing of the machine by dedicated support means 23c. According to such an embodiment, containers 8 of different sizes respectively volumes may be supported by the receiving seat 1, as shown for example in FIGS. 2a-b.

The preparation machine 20 further comprises a cooling unit 4 connected to a heat exchange element or cooling element 1a that is preferably connected to or integrally formed with the receiving seat 1 of the machine 20. The heat exchange element 1a is preferably an evaporator fluidically connected to the cooling unit 4 of the machine. The heat exchange element 1a thus serves as a heat exchanger that withdraws the heat energy from the container 8 and its enclosed confectionary product to lower rapidly the temperature of the product contained in the container.

The heat exchange element 1a is preferably shaped to overlap with and be arranged adjacent to an outer wall surface 8d and a heat exchange wall portion 12 of the container 8 (see FIGS. 2a, 2b) when the container is placed in the receiving seat 1 of the machine.

The heat exchange element 1a comprises a heat exchange contact surface 21 that is arranged to be in contact with the outer wall surface 8d of the container when the container 8 is placed in the machine. Thereby, the heat exchange contact surface 21 is arranged at an inner surface of the receiving seat 1. The heat exchange contact surface 21 of the heat exchange element 1a and the heat exchange wall portion 12 of the container 8 are preferably complementary shaped.

The heat exchange element 1a is preferably of a material that provides excellent heat transfer properties, preferably metal such as stainless steel, copper or aluminium. Accordingly, the heat transfer between the container 8 and the heat exchange element 1a is significantly enhanced.

As shown in FIG. 1, the container receiving seat 1 is preferably only partially composed of the heat exchange element 1a. The receiving seat 1 preferably further comprises a thermally insulating portion 1b made from material with a lower thermal heat capacity such as e.g. a polymer or plastic material. According to such an embodiment, the thermal inertia and thus energy losses are reduced, which allows a faster cooling of the container 8. The thermally insulating portion 1b further serves to insulate the sensing means from the external environment, in a tight manner against the wall of the container, so that a more accurate product temperature is obtained.

The machine 20 preferably comprises a control unit 6 for controlling the operations of the components of the machine. The control unit 6 is preferably connected at least to the cooling unit 4 and to temperature sensing means 100, as it will be further explained in more detail.

In a preferred embodiment, the temperature sensing means 100 is connected to the control unit 6 in order to control the cooling unit 4 of the machine 20 dependent on the actual temperature of a product 8b within the container 8.

The cooling unit 4 of the machine 20 is adapted to cool the heat exchange element 1a. Since the heat exchange element 1a comprises excellent heat conductivity, the container 8 and in particular the heat exchange wall portion 12 of the container 8 when being in contact with the heat exchange element 1a is effectively cooled. The cooling unit 4 can comprise any refrigeration and/or circulatory heat transfer system to cool the heat exchange element 1a, the heat exchange wall portion 12 and consequently the container 8 as rapidly as possible.

Optionally, the machine 20 may further comprise a liquid tank 2 for holding liquid such as e.g. water and a dedicated pump. The liquid tank 2 may be connected to liquid dispensing means 2a for providing liquid to the container 8 when being placed within the receiving seat 1 of the machine 20. The liquid tank 2 may be necessary when the initial product is powder, gel or liquid concentrate and so requires dilution according to a predetermined dilution ratio for achieving the final product with the correct texture.

Furthermore, the machine 20 may comprise one or more topping reservoirs 3 and an associated valve or pump (not shown) for providing toppings in solid or liquid form to the product 8b. The toppings may be liquid coulis, liquid chocolate, honey, caramel or solid products like crisps, flakes, chocolate bits. Additionally, the toppings may be liquefied by means of an additionally provided heating source such as e.g. melted chocolate.

The machine 20 further comprises a stirring unit 5 adapted to connect to a stirring member 9 and driving it in a combined movement (as will described in detail later on). For this reason, the stirring unit 5 is preferably equipped with connection means 5a designed for selectively connecting to the stirring member 9. The stirring member 9 may either be part of the machine 20 or be provided as part of the container 8 (integral or part to it). The stirring member is preferably a spoon.

The topping reservoirs 3 and the stirring unit 5 are preferably mounted on a mobile structure 7 of the machine in order to allow the insertion and removal of the container 8 into and from the container receiving seat 1. The mobile structure 7 is thus adapted to be moved relatively to the rest of a housing of the machine 20 from a closing position (shown in FIG. 1) to an open position (not shown). Thereby, the movement of the mobile structure 7 with respect to the rest of the machine 20 may be rotation or translation.

In the following, the basic working principle of the machine for preparation of frozen or cooled confectionary will be explained. As disclosed before, even if the preparation of cooled confectionary is the preferred embodiment of the invention, it shall not be limited to that but to preparation of a cooled or heated product.

First, the mobile structure 7 of the machine 20 is brought into its open position in which a container 8 from which a lid member provided to close a central opening 8c of the container 8 has been removed is inserted in the receiving seat 1. In the open position, the stirring member 9 may be manually connected to the stirring unit 5 of the machine.

The mobile structure 7 is then brought into its closed position in which the stirring unit 5 and the topping reservoirs 3 are lowered towards the container 8. In this position, the stirring member 9 is brought into a position adjacent to an inner surface 12a of the container 8.

The product within the container 8 will then be cooled by means of the heat exchange element 1a interacting with the outer wall surface 8d of the container and preferably with the heat exchange wall portion 12 thereof. At the same time, the stirring unit 5 may provide a motion of the stirring member 9 within the container 8.

The operation of the heat exchange element 1a is preferably set in response to a temperature detected by the temperature sensing means 100. Thereby, the general operation such as an on/off state of the heat exchange element 1a as well as the particular cooling temperature may be set in response to the temperature measured by said temperature sensing means 100.

During the preparation process, liquid or solid toppings may be added from the topping reservoirs 3 to the main product within the container 8. This preferably takes place close to the end of the preparation process such that liquid toppings will create an appealing visual swirl for the consumer and solid toppings will remain crispy.

When a predefined cooling temperature is reached and sensed by the temperature sensing means 100, the cooling operation is preferably stopped or reduced to hold the product at the optimal serving temperature.

The mobile structure 7 of the machine 20 is then brought into its open position such that the container 8 may be removed from the receiving seat 1. The stirring unit 5 may be adapted to disconnect from the stirring member 9 when bringing the mobile structure 7 in an open state. The stirring member 9 is therefore left in the final product and thus within the container 8. The stirring member 9 that is preferably shaped like a spoon may then be used for consumption of the prepared confectionary 8b. The container thus serves at the same time as initial container, process container and final container during the preparation of the frozen confection. Accordingly, no cleaning operations of the components of the machine are necessary.

With the described configuration, effective measurement of the temperature of the product held within the container 8 is enabled. Thereby, a hygienic solution is provided which does not require the provision of a temperature probe into the product within the container. Further, due to the measurement of the temperature at the outer wall surface 8d of the container, splashes occurring during the preparation process may be effectively prevented from contacting the temperature sensor 16.

As shown in FIGS. 2a and 2b, different containers 8′,8″ may be provided each of which enclose a different volume such as 300 ml, 200 ml or 150 ml, for example. Dependent on the product to be prepared by the respective container 8, the size and volume of the container 8 is adapted to contain a predefined amount of ingredients necessary for preparing the specific product (in the embodiments where the containers are configured as single-serve ones comprising at least part of the ingredients inside). The containers preferably comprise a shelf-stable comestible ingredient. In addition, the container may further comprise a gaseous phase such as e.g. air which is enclosed in a compartment 11 by means a lid member (not shown). In a preferred embodiment the amount of confectionary ingredients preferably ranges from 20 to 60% of the provided volume of the container. The rest of the container may be filled with gas. Alternatively or additionally, nitrogen can be provided within the container for aseptic filling and extended shelf life.

As already mentioned, a lid member (not shown) is preferably provided to each of the containers in order to close off aperture 8c of the container and thus, to enclose the ingredients therein, in the preferred embodiment for single-use containers.

As shown in FIGS. 2a and 2b, the different containers 8′,8″ preferably all comprise common technical parts, such as for example a heat exchange portion 12 of vertical projected height h0. Preferably, the containers may further comprise an additional heat conducting portion 17. Thereby, the heat exchange wall portion 12 and/or the additional heat conducting portion 17 are preferably of essentially identical outer diameter for all of the different containers 8′,8″. More preferably, the heat exchange wall portion 12 and/or the additional heat conducting portion 17 are of the same dimensions and shape for all of the different containers 8′,8″.

The additional heat-conducting portion 17 is preferably an annular portion of predefined vertical projected height h, which preferably lies between 5 and 15 mm. The additional heat-conducting portion 17 is preferably arranged axially distanced by a distance d from the heat exchange wall portion 12 of the container 8. The distance d preferably lies between 2 and 35 mm, more preferably between 5 and 25 mm.

According to the invention, the heat exchange wall portion 12 overlaps with the heat exchange contact surface 21 and the additional heat-conducting portion 17 is preferably positioned where the temperature sensing means 100 is in contact with the outer wall surface 8d of the container when the container 8 is placed in the receiving seat 1.

In an alternative mode, the heat exchange wall portion 12 and the additional heat-conducting portion 17 are formed into a single annular portion, thereby overlapping with the heat exchange element 1a and temperature sensor 16 when the container is in place in the seat of the machine. Such overlapping portion can so be a single band of vertical projected height h0+h (with no distance d).

The additional heat-conducting portion 17 may comprise a thickness t which is different from the rest of the container wall thickness. In particular, the additional heat-conducting portion 17 may comprise a reduced thickness of 10 to 30, preferably by 15 to 25% lower than the rest of the outer wall surface 8d of the container.

The additional heat-conducting portion 17 may be of different material compared to the rest of the outer wall surface 8d of the container and/or the heat exchange wall portion 12. The additional heat-conducting portion 17 may as well be made from the same material as the heat exchange wall portion 12 of the container.

Thereby, the additional heat-conducting portion 17 may at least be partially made from metal such as copper, aluminium and/or steal.

The additional heat-conducting portion 17 may as well comprise an integrally formed or externally applied layer of material with increased heat conductivity such as metal material in order to increase the heat conductivity through the outer wall surface 8d of the container 8.

The containers 8′,8″ preferably also comprise an upper rim portion 13 which is of essentially identical geometric shape. The upper rim portion 13 may be a portion of increased diameter of the container body 8a as indicated in FIGS. 2a and 2b. Alternatively or in addition, the upper rim portion 13 may as well comprise a flange-like rim portion or a curled outer rim portion (not shown).

The thickness of the container body 8a of the different containers 8′,8″ in particular the thickness of the heat exchange wall portion 12 is preferably identical, but may as well be different in order to obtain different thermal properties and thus cooling properties for the respective product to be prepared.

Each of the containers 8′,8″ has preferably an essentially conical shape. Alternatively, the container may as well have an essentially curved shape. According to such a shape of the container 8, an extension and/or retraction of the container body 8a due to variation of temperature will not negatively affect the proper support of the container 8 within the receiving seat 1 of the machine 20. In particular, a tight support between the container 8 and the receiving seat 1 and thus a close contact between the heat exchange wall portion 12 and the heat exchange element 1a is ensured.

The machine 20 may further comprises torque sensing means (not shown) connected to the control unit 6. Thereby, the control unit 6 which is adapted to control the stirring unit 5 and in particular the rotational speed and the electrical current of a dedicated motor thereof, may sense the torque which is proportional to the electrical current. Accordingly, the viscosity of the product to be prepared within the container 8 can be detected by the control unit 6 in order to monitor the preparation process and detect whether the product within the container is ready for consumption.

The control unit 6 may further be designed to control the stirring unit 5 in response to a temperature measured by the temperature sensor 6. The control of the stirring unit may be its velocity and/or its rotational direction.

In what follows, further detailed explanation of the temperature sensing means 100 will be done, also compared to known prior art solutions.

As shown in FIG. 3, different possibilities in a system for preparing a cooled or heated product similar to the one of the present invention are known in the state of the art: however, all these existing possibilities present associated drawbacks, such as:
In the case of using a close container 8, direct temperature measurement would be possible only when using a sensor already integrated inside the container 8: this solution would require cleaning of the sensor probe and would not be hygienic.
Another possibility would be to measure the temperature on the heating/cooling surface of the machine, for example the metallic evaporator 1a: however, in this solution, the temperature read would not reflect the product temperature that may have a high inertia, which in terms of reading would represent a delay between the two values.
Another alternative solution would be, for example, to use contactless sensors, for example based on infrared: this solution is however costly and sensitive to splashes or dirt, leading to wrong measurements.

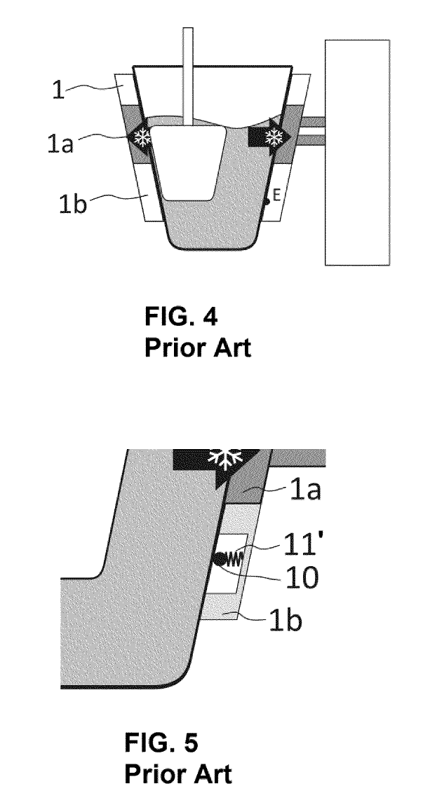

The system presented for example in document EP 13190810.5 belonging to the same applicant, consists in placing a temperature sensor 10 in a position E (as shown for example in FIG. 4 or 5) on the external side but in direct and close contact with the container 8, on an ideally conductive part of said container 8, and isolated from any other part of it that could induce heat transfer, may they be the cooling/heating surface or a parasitic source of heat such as a hot compressor, heating electronics or even ambient air.

In these conditions, the temperature sensor 10 allows the reading of a temperature value very close to the food product 8b, especially if the only element in-between, i.e. the container body 8a is conductive and has a low thermal inertia, which is the case if the thickness is low.

As shown in more detail in FIG. 5, in order to ensure a constant contact of the temperature sensor 10 and the container body 8a, a certain pressure is ideally necessary between them. This can be achieved by placing the temperature sensor 10 in a rigid manner on the thermally insulating portion 1b of the container and making use of the flexibility of the container body 8a or by placing the temperature sensor 10 in an elastic manner on the thermally insulating portion 1b using a system ensuring a constant pressure, for example a spring 11′, as represented in FIG. 5.

However, even when the temperature senses is very accurate, there still exists an offset between the temperature sensed and the real product temperature. This is due to the fact that it is impossible to ensure perfect conduction between the temperature sensor 10 and the product 8b inside the container 8 and because it is impossible to ensure perfect insulation between the temperature sensor 10 and the environment. Hence, in such a system as presented in FIGS. 4 and 5, the sensed temperature is an intermediate value between the product temperature and the environment temperature (as previously discussed, it is not possible to estimate two values based on only one sensed value). The accuracy of such a system is also highly dependent on the variation of the environment temperature, another factor to be taken into consideration.

Therefore, the present invention proposes temperature sensing means 100 comprising at least two distinct temperature sensors, typically a primary temperature sensor 101 and a secondary temperature sensor 102, placed at two different positions with respect to the container body 8a, allowing to estimate the product temperature in the container even when the environment temperature is changing.

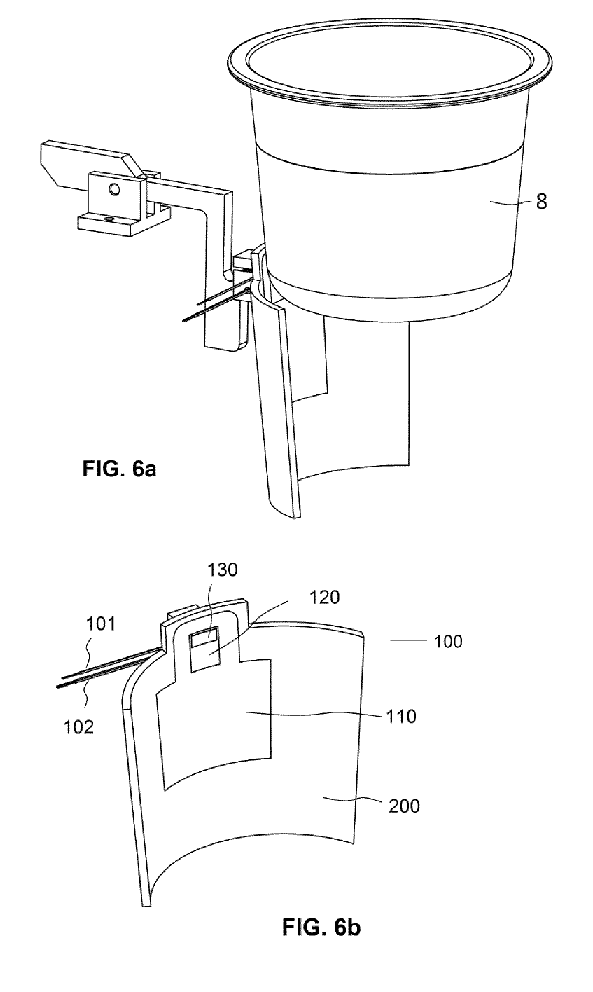

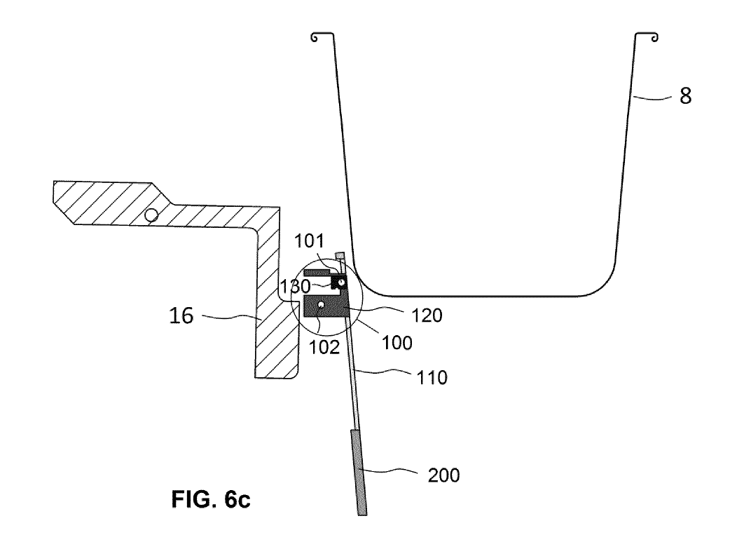

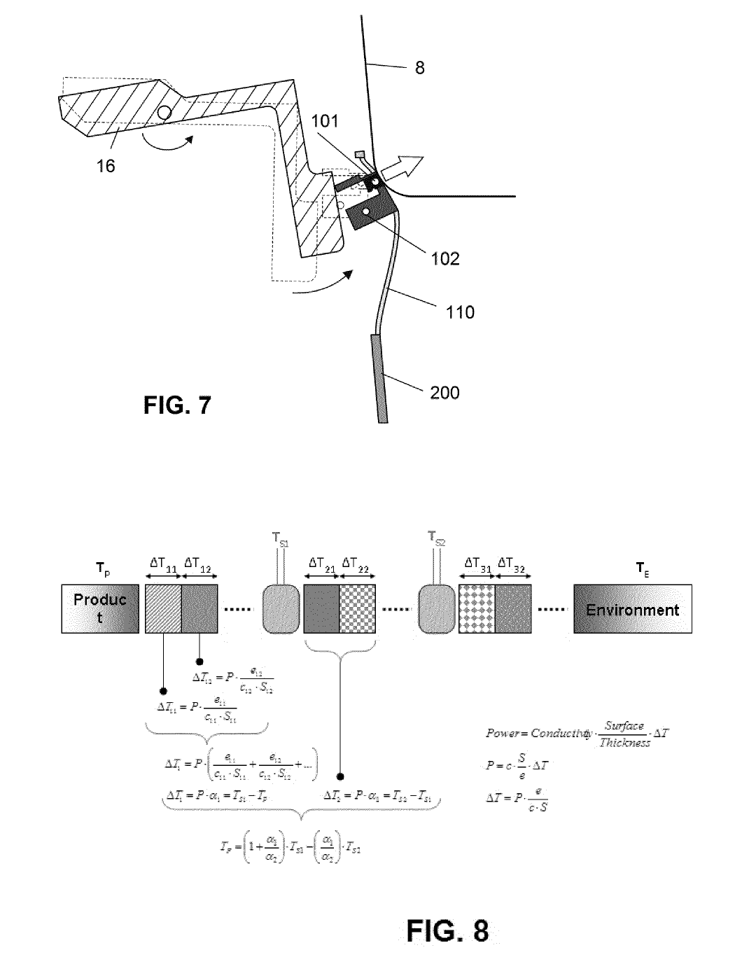

A preferred configuration of the temperature sensing means 100 in a machine 20 according to the present invention is shown in FIGS. 6a-b-c, for example. The thermally insulating portion 1b of the container in the prior art is now configured as an insulating part or insulating support 200 of the receiving seat 1 integrated in the machine 20. Typically, the primary and secondary temperature sensors 101, 102 are arranged as follows:
A primary temperature sensor 101 is placed in a highly conductive sensor support 130, ideally with a conductive grease or conductive glue to improve heat conduction. This highly conductive sensor support 130 is configured as small as possible to reduce thermal inertias, and is placed in an insulating movable support 120, as shown in FIG. 6b. The insulating movable support 120 can move because it is linked to the insulating support 200 (which is fixed) by means of a flexible membrane 110 made, for example, in rubber or silicone. The advantage of using a flexible membrane compared to for example using a spring system is that it ensures a continuity of the surface (the spring is more area/point focused) and improves the global hygiene of the system, as it is easy to clean.
A secondary temperature sensor 102 is placed on the insulating movable support 120, as represented in FIG. 6b or 6c.

The primary and/or secondary temperature sensors 101, 102 may be for example a thermocouple, thermistor or resistance temperature detector.

In the system of the invention, when a container 8 is placed in the receiving seat 1 and the mobile structure 7 of the machine is closed, pushing means 16, typically a lever, called in what follows lever 16, also part of the machine 20, rotates and pushes the insulating movable support 120 towards the container 8, so that the highly conductive sensor support 130 enters in contact with the container 8. In this condition, the primary temperature sensor 101 is only separated from the product 8b in the container 8 by means of a highly conductive element, the sensor support 130. The secondary temperature sensor 102 is arranged in such a position that it senses the temperature at a defined point on the heat path through which heat travels between the product 8b inside the container 8 and the environment. A schematic representation of such heat path appears in FIG. 8.

As shown in FIG. 8, between the product 8b in the container 8 and the environment, several components such as packaging, air gaps, supports for temperature sensors, or the like can be modeled using several blocks which conduct heat differently as a function of their material properties. At two defined locations, the two temperature sensors, primary and secondary temperature sensor 101, 102 are placed.

When a constant power loss P is considered through the heat path represented in FIG. 8, meaning that this path is properly insulated, the product temperature Tₚ can be calculated using a simple extrapolation with only the temperature T_{S1} sensed by the primary temperature sensor 101 and the temperature T_{S2} sensed by the secondary temperature sensor 102, as per:

$${T}_{P} = ( 1 + \frac{{α}_{1}}{{α}_{2}} ) \cdot {T}_{S 1} - ( \frac{{α}_{1}}{{α}_{2}} ) \cdot {T}_{S 2}$$

In the formula above, α₁ and α₂ are non-dimensional parameters representing the conductivity, surface dimension and thickness of the material layers between the product 8b and the primary temperature sensor 101 and between the primary temperature sensor 101 and the secondary temperature sensor 102, respectively. In fact, only the ratio (α₁/α₂) is relevant, but not the values α₁ or β₂ separately.

The calculation of this ratio (α₁/α₂) is either defined with the knowledge of each separated block and its thermal properties, or through an identification of the system, measuring T_{S1} and T_{S2} at different and well known product temperatures Tₚ and then extracting the mentioned ratio (α₁/α₂). Preferably, the system of the invention (machine and container) will be designed so that the conductivity between the product and where T_{S1} is measured is the highest, which translates into the ratio (α₁/α₂) being minimum, ideally equal to zero. In fact, with the system of the invention, what is calculated is the ratio (α₁/α₂) but not each separated value for α₁ or α₂.

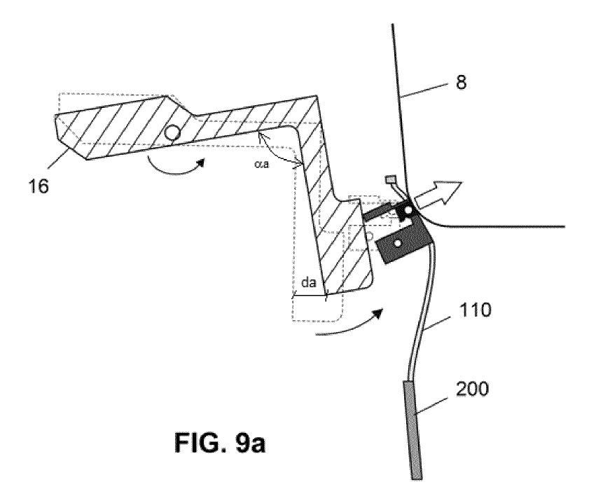

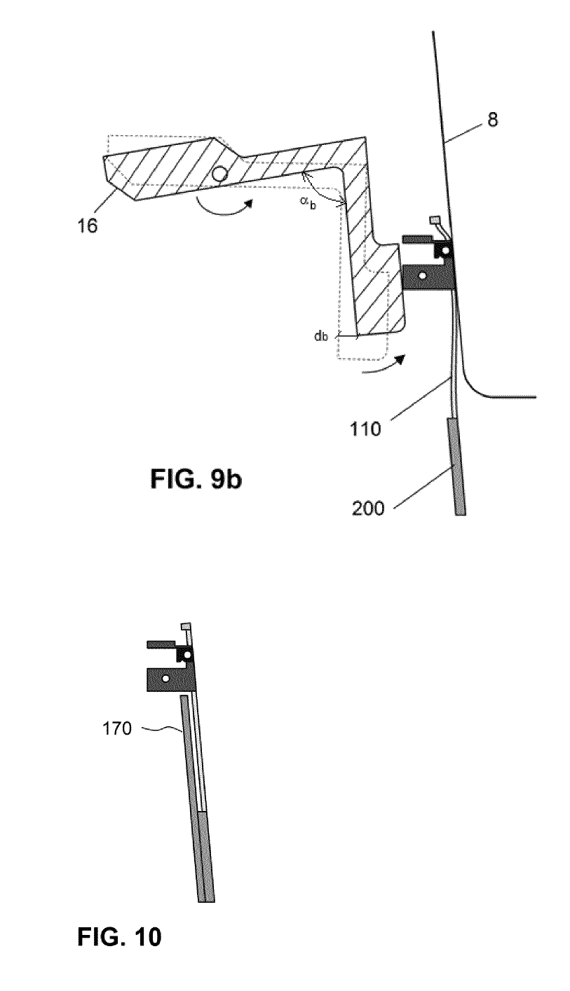

The lever 16 is preferably made having certain flexibility so that it complies with different sizes of the inserted container 8, as represented in FIGS. 9a and 9b. When a small container 8 is for example used (see FIG. 9a), the lever 16 will push and induce a movement of the insulating movable support 120. However, when a large container 8 is used, as shown in FIG. 9b, the lever 16 will push but not force the insulating movable support 120 that will stay in its idle or rest position, blocked by the bigger container 8.

The flexibility or compliance in the lever 16 according to the invention allows that contact of the sensing means 100 with the container 8 are ensured without using purely rigid parts. As a preferred embodiment, the lever 16 is allowed certain angular flexibility, thus varying the angles αₐ and α_{b}, as shown in FIGS. 9a and 9b, respectively. This configuration allows accommodating cups having different shapes that would require sensing means 100 at different positions and/or locations. Moreover, this configuration avoids any damage made on the container 8 and, even further, allows accommodating irregularities, tolerances and/or deviations on both the container 8 and/or the machine parts.

Preferably, according to the invention, the container 8 will comprise identification means (not shown) comprising the information on the type of product comprised within the container 8. Furthermore, the system of the invention will be able to know, by means of the position and adjusting of the lever 16, if the container 8 is a big container (that shown for example in FIG. 9b) or a small container (FIG. 9a). The identification means will then check that the product comprised in the container 8 is correlated or not with a big or small container, for example, which will be known by the positioning of the lever 16: a big container 8 will position the lever 16 with a distance d_{b} as shown in FIG. 9b, smaller than the distance dₐ (FIG. 9a) corresponding to a small container 8. According to the invention, a correlation can be made also with the type of material used for the container 8: for example, a big container 8 can be typically made in plastic and can comprise a certain type of product inside, while a small container 8 can be made for example in aluminum and can contain a different kind of product to prepare in the system of the invention. The control unit 6 will therefore read identification means in the container 8 and will adapt the formula or recipe to apply to the type of container 8, big or small, something that will be further checked by the positioning of the lever, under distances dₐ or d_{b}. That is to say, the lever 16 will have the adaptability (flexibility), varying the angle αₐ, α_{b}, to ensure contact of the sensing means 100 with the container 100, thus providing the control unit 6 with a distance dₐ or d_{b}, indicating a big or a small container to process. The control unit will further check this information with the information read on the identification means in the container 8, and will subsequently apply a corresponding recipe.

As previously mentioned, using a flexible membrane 110 is very useful as it offers a flat surface compared to a spring during cleaning. It is also important in the system of the invention that said flexible membrane 110 is prevented from being to pushed too much in the direction which is free, opposite to the container 8, which will may cause its breakage: for this reason, mechanical stops 170 are preferably arranged behind the membrane 110 in order to prevent this situation, as represented on FIG. 10.

In the preferred embodiment of the system of the invention, a rigid container 8, of the capsule type, is presented: however, the present invention is not limited to capsules nor to rigid container, and is also applicable to other types of packaging such as flexible packaging (pouches, sachets, etc.) where the flexibility of the packaging and the pressure of the contained product can precisely be used to ensure a tight contact to the sensor.

The present invention being simple and economic, it is feasible to use several sensors at different locations (at least two, but more than two temperature sensors could be therefore envisaged) in case the cooling is not homogeneous or simply to improve the reliability of the information.

The system of the present invention advantageously allows measuring the temperature of a product being cooled and/or heated inside a closed or semi-closed container without entering in direct contact with said product and without being disturbed or biased by the contact surface ensuring the cooling and/or heating function. Moreover, it improves the measurement accuracy with the use of two temperature sensors and an extrapolation method.

Some of the most important features of the system of the invention are:
direct contact with the container, preferably using a pressure ensuring the tightness;
insulation to any external disturbance;
two temperature sensors and the extrapolation method.

Although the present invention has been described with reference to preferred embodiments thereof, many modifications and alternations may be made by a person having ordinary skill in the art without departing from the scope of this invention which is defined by the appended claims.

1. A machine for the preparation of a cooled or heated product comprising:
a receiving seat for accommodating a container comprising at least part of the ingredients for the preparation of a product;
a heat exchange element arranged to be in contact with an outer wall of the container, when the container is placed in the receiving seat;
temperature sensor arranged to measure the temperature at an outer wall of the container when the container is placed in the receiving seat; and
the temperature sensor comprises at least two temperature sensors, a primary temperature sensor arranged to measure the temperature (T_{S1}) in proximity to an outer wall of the container and a secondary primary sensor arranged to measure the temperature (T_{S2}) in a position located in the heat path through which heat travels between the inside of the container and the external environment.

2. Machine according to claim 1 wherein the temperature in the product (Tₚ) is extrapolated from the temperature (T_{S1}) measured by the primary temperature sensor and the temperature (T_{S2}) measured by the secondary temperature sensor.

3. Machine according to claim 2 further comprising a control unit arranged to make an extrapolation between the two sensed temperatures (T_{S1}, T_{S2}) and calculate the product temperature (Tₚ).

4. Machine according to claim 2 wherein the extrapolation is made using pre-identified values that represent the conductivity, the surface dimension and the thickness of the material layers between the product in the container and the primary temperature sensor, and between the primary temperature sensor and the secondary temperature sensor.

5. Machine according to claim 1 comprising a pushing member configured to cooperate with the temperature sensor in order to ensure contact of the temperature sensor with an outer wall of the container.

6. Machine according to claim 5 further comprising a flexible membrane configured to cooperate with the pushing member adapting to containers having different sizes.

7. Machine according to claim 6 further comprising mechanical stops arranged to cooperate with the flexible membrane and limit its deformation at least in one of its directions of deformation.

8. Machine according to claim 1 wherein at least one of the two sensors is arranged in an insulating movable support being movable to assure contact of the temperature sensor with an outer wall of the container.

9. Machine according to claim 1 wherein at least one of the two sensors is arranged in a highly conductive support ensuring a high conductivity path between the at least one sensor and an outer wall of the container.

10. Machine according to claim 9 wherein the temperature are sensor is arranged within an insulating support isolating them from the external environment.

11. Machine according to claim 10 wherein the insulating support is made of a material selected from the group consisting of rubber, silicon, and foam.

12. System comprising a machine for the preparation of a cooled or heated product comprising: a receiving seat for accommodating a container comprising at least part of the ingredients for the preparation of a product; a heat exchange element arranged to be in contact with an outer wall of the container, when the container is placed in the receiving seat; temperature sensor arranged to measure the temperature at an outer wall of the container when the container is placed in the receiving seat; and the temperature sensor comprises at least two temperature sensors, a primary temperature sensor arranged to measure the temperature (T_{S1}) in proximity to an outer wall of the container and a secondary primary sensor arranged to measure the temperature (T_{S2}) in a position located in the heat path through which heat travels between the inside of the container and the external environment and a container cooperating with such machine to prepare a cooled or heated product within the container.

13. System according to claim 12 wherein the container comprises an additional heat conducting portion arranged where the temperature sensor contacts an outer wall of the container when the container is placed in the receiving seat of the machine.

14. System according to claim 12 wherein the container is rigid.

15. System according to claim 12 wherein the product in the container is prepared adapted to the type of container, its size and/or its type of material.
